(19) United States
(12) Patent Application Publication
(10) Pub. No.: US 2007/0240208 A1
(43) Pub. Date: Oct. 11, 2007

(54) Network appliance for controlling hypertext transfer protocol (HTTP) messages between a local area network and a global communications network

(76) Inventors: Ming-Che Yu, Kao-Hsiung City (TW); Shao-Chi Lu, Hsinchu County (TW)

Correspondence Address: NORTH AMERICA INTELLECTUAL PROPERTY CORPORATION, P.O. BOX 506, MERRIFIELD, VA, 22116, US

(21) Appl. No.: 11/279,114

(22) Filed: Apr. 10, 2006

(51) Int. Cl. G06F 15/16

(52) U.S. Cl. 726/13

(57) ABSTRACT

A network appliance for controlling hypertext transfer protocol (HTTP) messages between a local area network and a global communications network includes a housing; a receiving and forwarding module installed within the housing and coupled to the local area network and the global communications network, the receiving and forwarding module for communicating HTTP messages between the local area network and the global communications network; and an interception module installed within the housing and coupled to the receiving and forwarding module, the interception module having hardware that filters HTTP messages originating from the local area network and bound for the global communications network according to a predetermined condition residing in firmware of the interception module.

### BACKGROUND OF THE INVENTION

1. Field of the Invention

The present invention relates to computer networks, more particularly, a network appliance for controlling hypertext transfer protocol (HTTP) messages between a local area network and a global communications network.

2. Description of the Prior Art

The maturation and modernization of technology continues to provide continual advancements in the area of network systems and communications. Networks play a key role in providing information exchange between network terminals, typically comprising at least a user terminal and a network host (or server). Examples of communications networks can include: cellular mobile phone systems, local area computer networks (LAN), wireless area networks (WAN) and even global computer networks such as the Internet.

In typical network configurations, a proxy server is generally implemented within the user system. A proxy server is basically an intermittent component that sits between a client application, such as a web browser, and a real network server. The proxy server acts to intercept all requests sent to the real server, and if possible, fulfill the request itself. If it cannot fulfill the request by itself, it forwards the request to the real server.

Proxy servers offer two main advantages when integrated into a network system. The main advantage is that it helps provide and improved network performance for user groups. This is because it saves the previous results of network requests for a predetermined amount of time. For example, suppose there were two terminal users on the same network accessing the Internet through a proxy server. If the first terminal requests a specific web page, the proxy server would store the data related to the requested web page for a predetermined amount of time. If the second terminal requests the same web page, the proxy server would simply return the fetched webpage that it has already stored. This can dramatically reduce communication times as there is no need to forward the second request to the web server and wait for a reply. Furthermore, proxy servers are typically implemented on the same network as the user, helping make this an even faster operation.

Another benefit to having a Proxy Server is its ability to filter specific requests. For example, a company may use a proxy server to prevent its employees from accessing certain sets of web sites. It can also verify that the client terminal has the proper authorization to access specific material on the host server. A proxy server can also act to detect and intercept potential hazardous material, including viruses and spam, from the remote web server and reject it from being sent to the client application terminal. In this way, the proxy server can act as a firewall to intercept and control the flow of HTTP messages over the communications network.

FIG. 1 illustrates an HTTP communications system of the prior art 100 which can be utilized for this task. The system 100 comprises one or more of a number of client or user machines 120, and a proxy server 130. The user machines 120 and the proxy server 130 generally form the local area network (LAN), or intranet 110. The system further comprises additional hardware network components 140, possibly being a router, a bridge, a switch, or a combination of the above, being connected to the Internet 150. The intranet 110 is usually a private network isolated from the Internet 150 through a firewall related to functions of the proxy server 130. The hardware network components 140 act to forward or send HTTP messages according to a desired predetermined hardware configuration.

The process of communications from the user machines 120 to the Internet 150 is as follows. Requests to the Internet 150 from the user machines 120 are sent in by means of packets of data comprising the HTTP message. Within the HTTP message, exists certain fields and integers, comprising: source IP (Internet protocol), destination IP, source TCP (Transmission Control Protocol) port, destination TCP port and more.

The proxy server 130 receives the message from the user machines 120 and compares the fields of each HTTP message against certain rules that are predetermined by a network administrator. In this way, the proxy server can authenticate the sending user machine and determine whether it has the access or permission to access the Internet 150 for the requested data. If the HTTP message is verified and approved, it is passed to the hardware network components 140, and properly routed to the Internet 150. Otherwise, if the HTTP message cannot be verified or is not approved, it is either discarded or sent back to the originating user machine.

Traditional methods use a transparent proxy server 130 that is implemented on the same local area network 110 as the user. Generally, it is software based within the user machine 120, or the local area network 110 server. Although this offers the advantage that it can be transparent from the user and produce fast access times, it can require considerable memory and processing resources for proper functionality. This burden that the proxy server 130 places on the local area network 110 may therefore take away from the processing capability of the client user machines 120 and the reduce the performance of the local area network 110.

### SUMMARY OF THE INVENTION

A goal of the present invention is to provide a network appliance for controlling HTTP messages between a local area network and a global communications network. The appliance implements the use of an interception module separate of the local area network, in order to relieve memory and processing resources otherwise required of the local area network. This allows parallel processes of the local area network to run uninhibited without reduced computing power. The network appliance of the present invention also provides a method to filter HTTP messages by way of examining fields of each message against predetermined conditions.

A network appliance for controlling hypertext transfer protocol (HTTP) messages between a local area network and a global communications network is disclosed. The network appliance comprises a housing; a receiving and forwarding module installed within the housing and coupled to the local area network and the global communications network, the receiving and forwarding module for communicating HTTP messages between the local area network and the global communications network; and an interception module installed within the housing and coupled to the receiving and forwarding module, the interception module having hardware that filters HTTP messages originating from the local area network and bound for the global communications network according to a predetermined condition residing in firmware of the interception module.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a hypertext transfer protocol (HTTP) communications system according to the prior art.

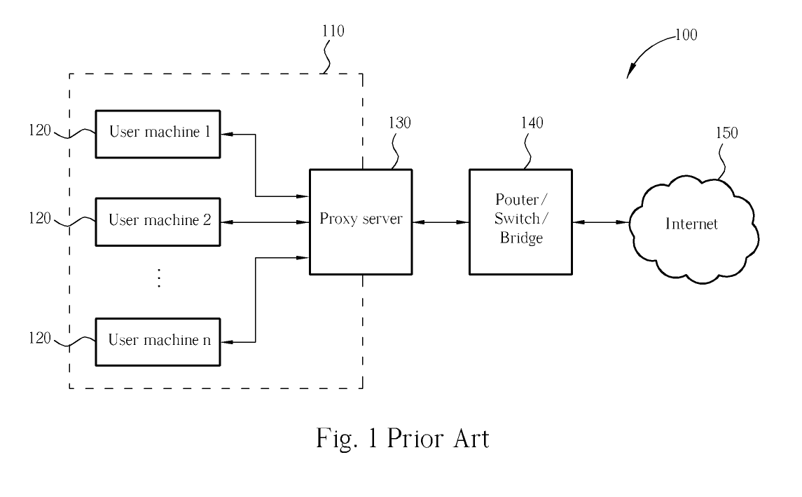

FIG. 2 illustrates an embodiment of a network appliance for controlling hypertext transfer protocol (HTTP) messages between a local area network and a global communications network, including the Internet.

FIG. 3 illustrates a flow chart diagram describing the process of the network appliance according to the present invention.

### DETAILED DESCRIPTION

When a proxy server is implemented within a local area network, comprising a local area network server or even the user terminal, it requires significant memory and processing resources of the host computer for proper operation. The consumption of memory resources and processing requirements may act to slow down adjacent terminal operations by the network user. The present invention therefore provides a network appliance for controlling hypertext transfer protocol (HTTP) messages between a local area network and a global communications network to solve the above-mentioned problem.

Generally, a user operating through a user terminal will aim to seek information on a global communications network. More particularly, the user may request a particular web page, or group of web pages through a web browser available through the Internet. The network appliance of the present invention acts to control the flow of information, comprising HTTP messages, which embodies key fields and parameters within. It accomplishes this by examining certain fields within each HTTP message to test for a match to a predetermined condition. According to the result of the match, the HTTP message is either discarded or forwarded to the appropriate destination IP address. In this manner, present invention thereby acts to filter HTTP requests accordingly.

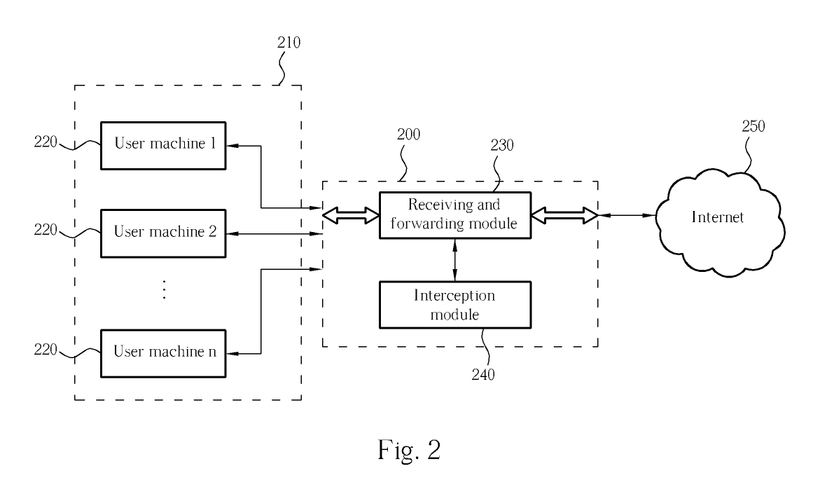

With reference to FIG. 2, an embodiment of the network appliance 200 for controlling hypertext transfer protocol (HTTP) messages between a local area network and a global communications network is shown. The configuration comprises: a local area network 210 coupled to the network appliance 200, which is further coupled to the Internet 250. The local area network 210 can be a private network system comprising one or more user machines 220. The network appliance 200 sits in between the local area network 210 and the internet 250, and further comprises a housing that contains a receiving and forwarding module 230 and an interception module 240. The receiving and forwarding module 230 is connected between the local area network 210 and the Internet 250, while the interception module 240 is connected to the receiving and forwarding module 230. The receiving and forwarding module 230 can comprise hardware of one or a combination of a router, a switch or a bridge.

The interception module 240 acts to control communications between a client user machine 220 and the Internet 250. When an HTTP message is sent from a client from the user machine to the Internet 250, it is first accepted by the receiving and forwarding module 230 and examined by the interception module 240. Upon examination of the message, the interception module 240 may conditionally allow forwarding of the message to the Internet 250, or reject the message. Rejection of the message may include simply discarding the message or returning the message to the originating user machine 220. A reply message may also be produced and sent to the originating user machine 220 according to the configuration of the interception module 240. If the HTTP message passes the examination criterion, it is forwarded to the Internet 250 according to the receiving and forwarding module 230 of the network appliance 200. The network appliance 200 will then also allow the transfer of the desired HTTP content from the Internet 250 back to the originating user machine 220.

An HTTP message intercepted by the interception module 240 will comprise a media access control (MAC) layer and a network (or IP) layer. The message field will contain a destination MAC address and an IP address pointed to the host web server of the Internet 250. When the interception module 240 is integrated with router hardware as the receiving and forwarding module 230, the destination MAC address is used to point to the receiving and forwarding module 230 (router), and the IP address is the destination address the HTTP message is sent to upon authorization by the interception module 240. When the interception module 240 is integrated with bridge or switch hardware as the receiving and forwarding module 230, both the destination MAC and IP layer address are unused.

The examination procedure by the interception module 240 is further detailed below.

Upon interception of the message, the interception module 240 verifies several fields of the HTTP message to see if the fields match any of a plurality of predetermined conditions for filtering. The conditions are programmable, and set by an administrator of the interception module 240. The predetermined conditions may comprise of static matching criteria, dynamic runtime states or a combination of individual criteria of both types.

The matching criteria for the fields of the HTTP message further comprises: source MAC addresses, source IP addresses, destination MAC addresses, destination IP addresses, destination TCP port numbers, URL and URI fields, and any possible HTTP header tags. Possible runtime states used for verification may also comprise: the state of authentication, statistics of cumulative traffic amount, amount of concurrent connections among peers or the scheduling of time.

A network administrator can customize each predetermined condition for filtering according to a set of matching criteria, and set a predetermined response pending the outcome of the match. For example, if the HTTP message matches a first condition, the HTTP message will be forwarded to its destination host server over the Internet. However, the HTTP message is found matching a second condition, it will be sent to an alternate host server. If the message does not match any set condition, it will be rejected and sent back to the originating user terminal. Each matching condition and response can be highly customized according to the requirements of the network and its administrators.

To further highlight the functionality and possibilities of the present invention, two examples are provided below:

### EXAMPLE 1

In this example, a predetermined condition is utilized that examines a specific URL and source IP address as the matching criteria. If the HTTP message is found to match this condition for the given criteria, the programmed response of the interception module 240 is to reject with message, and send a reply message string to the originating user machine stating “restricted web site” along with other HTTP tags.

A user machine 220 begins by sending an HTTP request message using a web browser to the Internet. This HTTP message is then accepted by the receiving and forwarding module 230 of the network appliance 200, and found to match the predetermined condition above at the interception module 240. The interception module 240 will then discard the HTTP message, and send the appropriate reply message described above to the originating user machine 220 for display on its web browser.

### EXAMPLE 2

Another predetermined condition utilizes a source IP address and a runtime state of authentication as its matching criteria. The programmed response for this condition is to reject the HTTP message, and send a reply message to the originating user machine. The reply message includes the string “user authentication is required” along with an alternative script to redirect the browser to the authentication page.

A user machine 220 sends an HTTP request message using a web browser to the Internet 250. Again, this HTTP message is intercepted, and examined by the interception module 240 of the network appliance 200. The HTTP message does not meet the matching criteria of the predetermined condition stated above (i.e., the source IP address and runtime state of authentication do not match). Therefore, the interception module 240 releases the HTTP message and allows it to be sent through by use of the receiving and forwarding module 230. Upon retrieving the HTTP data, it will be displayed on the web browser of the originating user machine 220.

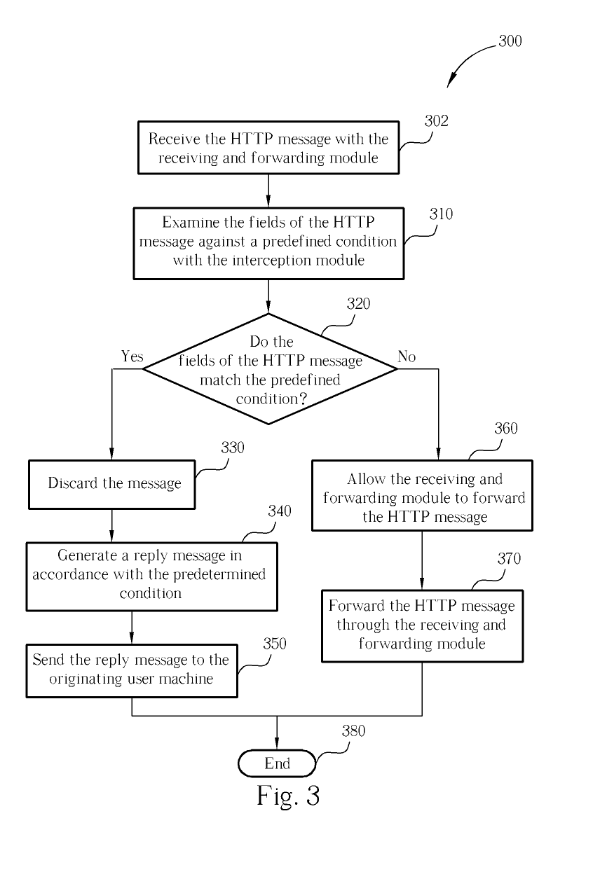

FIG. 3 shows a flow chart diagram illustrating the process 300 of the network appliance 200 according to the present invention. Provided that substantially the same result is achieved, the steps of the process 300 need not be in the exact order shown and need not be contiguous, that is, other steps can be intermediate. The process is described as follows:

Step 302: Receive the HTTP message from the local area network 210 through the receiving and forwarding module 230.

Step 310: Examine the fields of the HTTP message against a predefined condition with the interception module 240.

Step 320: Determine if the fields of the HTTP message match the predefined condition. If the fields of the HTTP message match the predefined condition, go to Step 330. If the fields of the HTTP message do not match the predefined condition, go to Step 360.

Step 330: Discard the message.

Step 340: Generate a reply message in accordance with the predetermined condition (if specified).

Step 350: Send the reply message to the originating user machine 220 in accordance to the predetermined condition, then go to step 380.

Step 360: Allow the receiving and forwarding module 230 to forward the HTTP message.

Step 370: Forward the HTTP message through the receiving and forwarding module 230.

Step 380: End.

The present invention therefore provides a network appliance for controlling HTTP messages between a local area network and a global communications network. This appliance does not further burden the memory requirements and processing resources of the local area network that is part of the system, but rather, it implements the use of an interception module separate of the local area network to allow parallel processes of the local area network to run uninhibited at an optimum processing power. Furthermore, the network appliance of the present invention provides a method to filter HTTP messages by way of examining fields of each message against predetermined conditions. The predetermined conditions are programmed by a network administrator and can be customized according to desired network requirements. Should an HTTP message be found matching any of a set of predefined conditions, a predetermined course of action can be carried out. These actions may comprise, forwarding the message to its destination IP address, discarding the message, sending a programmed reply message, and redirecting the message to an alternate IP address.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A network appliance for controlling hypertext transfer protocol (HTTP) messages between a local area network and a global communications network, comprising:
a housing;
a receiving and forwarding module installed within the housing and coupled to the local area network and the global communications network, the receiving and forwarding module for communicating HTTP messages between the local area network and the global communications network; and
an interception module installed within the housing and coupled to the receiving and forwarding module, the interception module having hardware that filters HTTP messages originating from the local area network and bound for the global communications network according to a predetermined condition residing in firmware of the interception module.

2. The network appliance of claim 1 wherein the global communications network comprises the Internet.

3. The network appliance of claim 1 wherein the hardware of the interception module compares a field of the HTTP message against the predetermined condition, the predetermined condition programmed according to a network administrator for determining an action of the interception module when the field of the HTTP message matches the predetermined condition.

4. The network appliance of claim 3 wherein the hardware of the interception module allows the receiving and forwarding module to send the HTTP message to a destination IP address of the global communications network when a field of the HTTP message does not match the predetermined condition.

5. The network appliance of claim 3 wherein the hardware of the interception module discards the HTTP message when a field of the HTTP message matches the predetermined condition.

6. The network appliance of claim 5 wherein the hardware of the interception module generates a reply message and sends the reply message to an originating user machine of the local area network.

7. The network appliance of claim 3 wherein the hardware of the interception module forwards the HTTP message to an alternate IP address of the global communications network when a field of the HTTP message matches the predetermined condition.

8. The network appliance of claim 1 wherein the hardware of the interception module compares a field of the HTTP message against a set of predetermined conditions, the hardware of the interception module for:
allowing the receiving and forwarding module to send the HTTP message to a destination IP address of the global communications network when the field of the HTTP message does not match any predetermined condition of the set of predetermined conditions;
discarding the HTTP message and generating a reply message sent to an originating user machine of the local area network when the field of the HTTP message matches a first predetermined condition of the plurality of predetermined conditions; and
forwarding the HTTP message to an alternate IP address of the global communications network when the field of the HTTP message matches a second predetermined condition of the set of predetermined conditions.
